(19) United States
(12) Patent Application Publication
(10) Pub. No.: US 2026/0113279 A1
(43) Pub. Date: Apr. 23, 2026

(54) SWITCH, DATA TRANSMISSION METHOD, AND SYSTEM FOR REDUCING DATA EXCHANGE LATENCY

(71) Applicant: NXCoreBase Semiconductor Corporation, Shanghai (CN)

(72) Inventors: Hong-Chain Chen, Shanghai (CN); Chia-Chi Chen, Shanghai (CN)

(73) Assignee: NXCoreBase Semiconductor Corporation, Shanghai (CN)

(21) Appl. No.: 19/359,124

(22) Filed: Oct. 15, 2025

(30) Foreign Application Priority Data
Oct. 17, 2024 (CN) 2024114493648

(51) Int. Cl. H04L 47/28; H04L 47/30

(52) U.S. Cl. CPC H04L 47/28; H04L 47/30

(57) ABSTRACT

The present disclosure discloses a switch, a data transmission method, and a system for reducing data exchange latency. The switch comprises a plurality of data transmission ports electrically interconnected. Each port comprises a receiving end and a sending end, and the receiving end and the sending end are respectively configured with a buffer. The receiving end receives and forwards the data to the sending ends of other ports. The receiving end receives and stores data comprising a destination address into corresponding buffer. When completing reception of the destination address, the receiving end sends a request including the destination address to the sending ends. The sending end whose port address matches the destination address returns an acknowledgement to the receiving end. Upon receiving the acknowledgement, the receiving end sends data to the corresponding sending end. The present disclosure can reduce data exchange latency and improve data transmission efficiency.

### CROSS-REFERENCE TO RELATED APPLICATIONS

This application claims priority to Chinese Patent Application No. 2024114493648 filed Oct. 17, 2024, the entire contents of which are herein incorporated by reference.

### FIELD

The present disclosure relates to the field of computer technology, and more particularly, to a switch, a data transmission method, and a system for reducing data exchange latency.

### BACKGROUND

In modern computer systems, a switch is a crucial device used to connect multiple computers or other network devices to achieve high-speed data transmission. The primary function of a switch is to forward received data to specified output ports according to specific rules. The performance of the switch, especially the data transmission latency, directly affects the performance of the entire computer system.

Modern high-speed data transmission buses have phased out traditional unidirectional transmission buses in favor of bidirectional transmission buses. For example, the PCIe (Peripheral Component Interconnect Express) bus is a high-speed serial computer expansion bus standard that provides high-bandwidth and low-latency data transmission capabilities, widely used in computer systems. The PCIe bus supports bidirectional transmission, meaning that data can be transmitted in both directions simultaneously within the same clock cycle.

Currently, switches typically employ store-and-forward technology to transmit data. As shown in FIG. 1, in this switch data transmission technology, a receiving end would completely receive the data before transmitting it to other receiving ends. The advantage thereof is that it ensures the accuracy of data transmission. However, this switch technology presents significant issues in terms of data transmission latency. Since data needs to be completely received before it can be sent, even after confirming the destination address of the received data, it is still necessary to wait for the subsequent data to be completely received before sending, which results in higher latency. Furthermore, existing switch technologies cannot fully utilize the bidirectional transmission capability provided by the bus. During a device sends data to the switch, it cannot simultaneously receive data from other devices, which further increases data transmission latency.

The disclosure of the above background art content is only for the purpose of assisting in the understanding of the inventive concept and technical solutions of the present disclosure, and it is not necessarily the traditional art of the present application, nor does it necessarily provide technical teaching. In the absence of clear evidence that the above content has been disclosed before the filing date of the present application, the above background art should not be used to evaluate the novelty and inventiveness of the present application.

### SUMMARY

The purpose of the present disclosure is to provide a switch, a data transmission method, and a system for reducing data exchange latency, which can reduce data exchange latency and improve data transmission efficiency.

To achieve the above object, the technical solutions adopted by the present disclosure are as follows:

A switch for reducing data exchange latency, the switch comprising a plurality of data transmission ports electrically interconnected, wherein each data transmission port is configured with a port address, port addresses corresponding to different data transmission ports are different, and each data transmission port comprises a receiving end and a sending end; the receiving end is configured with a corresponding receiving end buffer, which is configured to store data received by the receiving end; and the sending end is configured with a sending end buffer, which is configured to store data received by the sending end;
the receiving end of the data transmission port is configured to receive data transmitted from an external source to the switch and to forward the data to the sending ends of other data transmission ports; the sending end of the data transmission port is configured to receive the data sent from the receiving ends of the other data transmission ports;
the receiving end of the data transmission port receives data and stores the data into corresponding receiving end buffer thereof, the data comprising a destination address, which is one of the plurality of port addresses;
when completing the reception of the destination address of the data, the receiving end sends a data transmission request to the sending ends of the other data transmission ports, the data transmission request comprising the destination address;
the sending ends of the other data transmission ports receive the data transmission request and match the destination address with corresponding port addresses thereof, and the sending end whose port address is matched returns an acknowledgement signal to the receiving end;
the receiving end, in response to receiving the acknowledgement signal, sends data to the sending end that returned the acknowledgement signal, and the sending end receives the data and stores the data into corresponding sending end buffer thereof.

Further, in any one of the preceding technical solutions or a combination of multiple technical solutions, the switch comprises N data transmission ports, and the N data transmission ports are arranged on N circuit layers;
each circuit layer comprises the receiving end of one of the data transmission ports and the sending ends of the other data transmission ports, and the receiving end of one data transmission port is electrically connected to the sending ends of the other data transmission ports respectively.

Further, in any one of the preceding technical solutions or a combination of multiple technical solutions, data transmission is performed between the receiving end and the sending ends on the same circuit layer, and no data transmission is performed between receiving end and sending ends on different circuit layers.

Further, in any one of the preceding technical solutions or a combination of multiple technical solutions, data transmission between the receiving end and the sending ends on each circuit layer is performed independently; and/or,
data transmission between the receiving end and the sending ends on each circuit layer can be performed simultaneously.

Further, in any one of the preceding technical solutions or a combination of multiple technical solutions, during the receiving end is sending data to the sending end, the data in the receiving end buffer corresponding to the receiving end is synchronously retained;
the data stored in the receiving end buffer is cleared only after the receiving end has completed sending one set of data to the sending end.

Further, in any one of the preceding technical solutions or a combination of multiple technical solutions, when the data transmission from the receiving end to the sending end is interrupted or aborted, then all the data from corresponding receiving end buffer thereof would be sent to the sending end when the receiving end sends data again, and the sending end receives the data and stores and/or replaces the data in corresponding sending end buffer thereof.

Further, in any one of the preceding technical solutions or a combination of multiple technical solutions, the sending end receives data and synchronously forwards the received data to the exterior of the switch.

Further, in any one of the preceding technical solutions or a combination of multiple technical solutions, during the sending end is sending data to the exterior of the switch, the data in the sending end buffer corresponding to the sending end is synchronously retained;
the data stored in the sending end buffer is cleared only after the sending end has completed sending one set of data to the exterior of the switch.

Further, in any one of the preceding technical solutions or a combination of multiple technical solutions, when the data transmission from the sending end to the exterior of the switch is interrupted or aborted, then all the data from corresponding sending end buffer thereof would be sent to the exterior of the switch when the sending end sends data again.

Further, in any one of the preceding technical solutions or a combination of multiple technical solutions, at the same moment, one receiving end buffer retains only one set of data; and/or,
at the same moment, one sending end buffer retains only one set of data.

According to another aspect of the present disclosure, a data transmission method for reducing latency is provided for transmitting data among a plurality of data transmission ports electrically interconnected, comprising the following steps:
configuring a port address for each data transmission port, and configuring a receiving end and a sending end for each data transmission port, the receiving end being configured with a corresponding receiving end buffer to store data received by the receiving end, and the sending end being configured with a sending end buffer to store data received by the sending end;
the receiving end of the data transmission port is configured to receive data and forward the data to sending ends of other data transmission ports; the sending end of the data transmission port is configured to receive the data sent from the receiving ends of the other data transmission ports;
the receiving end of the data transmission port receives data and stores the data into corresponding receiving end buffer thereof, the data comprising a destination address, which is one of the plurality of port addresses;
when completing reception of the destination address of the data, the receiving end sends a data transmission request to the sending ends of the other data transmission ports, the data transmission request comprising the destination address;
the sending ends of the other data transmission ports respectively receive the data transmission request and match the destination address with corresponding port addresses thereof, and the sending end whose port address is matched returns an acknowledgement signal to the receiving end;
the receiving end, in response to receiving the acknowledgement signal, sends data to the sending end that returned the acknowledgement signal, and the sending end receives the data and stores the data into corresponding sending end buffer thereof.

Further, in any one of the preceding technical solutions or a combination of multiple technical solutions, the method further comprises configuring the receiving end of each of the data transmission ports to be electrically connected with the sending ends of the other data transmission ports;
the receiving ends of different data transmission ports and the sending ends of the other data transmission ports perform data transmission mutually independently.

Further, in any one of the preceding technical solutions or a combination of multiple technical solutions, the sending end receives data and synchronously sends the received data to an external destination; and/or,
during the receiving end is sending data to the sending end, the data in the receiving end buffer corresponding to the receiving end is synchronously retained; the data stored in the receiving end buffer is cleared only after the receiving end has completed sending one set of data to the sending end.

According to another aspect of the present disclosure, a data transmission system is provided, which performs data transmission using the data transmission method for reducing latency according to any one of the preceding technical solutions or a combination of multiple technical solutions.

The beneficial effects brought by the technical solutions provided by the present disclosure are as follows:
a. In the switch provided by the present disclosure, the receiving end of each data transmission port does not need to completely receive the data before proceeding the next step of data transmission. After finishing receiving the destination address in the data, it generates a data transmission request and sends it to the sending ends of other data transmission ports. Upon receiving the acknowledgement signal returned from the corresponding sending end, the receiving end sends data to the corresponding sending end while simultaneously receiving data itself. This saves a significant amount of time for storing data in the receiving end buffer and the sending end buffer, as well as the time required to wait for sending data, effectively reducing the latency of the data exchange process and improving data transmission efficiency.
b. When the switch provided by the present disclosure comprises N data transmission ports, the N data transmission ports are arranged on N circuit layers. Each circuit layer includes the receiving end of one data transmission port and the sending ends of the other data transmission ports, and the receiving end of the one data transmission port is electrically connected to the sending ends of the other data transmission ports respectively. The receiving ends and sending ends of different data transmission ports on each circuit layer perform data transmission mutually independently and simultaneously. This not only improves the efficiency of data transmission and reduces data transmission latency, but also ensures that the data transmission channels do not interfere with each other, guaranteeing the reliability of data transmission.
c. The switch and data transmission method provided by the present disclosure optimize the data re-transmission mechanism. On one hand, during the receiving end and the sending end are sending data, the data in their corresponding buffers is synchronously retained until the entire data transmission is complete. On the other hand, when data re-transmission is required after an interruption or abortion, the data transmission mode within the switch can be changed. Only one set of data is retained in the sending buffers and receiving buffers. For example, when the destination end (external device) fails a data check, the destination end will discard/abort the data transmission. During re-transmission, the entire data in the buffers of the receiving end and sending end can be re-transmitted to the destination address, without needing to find the data location in the buffer. This reduces the latency of data re-transmission, improves the efficiency of data re-transmission, and solves the problem of data re-transmission efficiency.

### BRIEF DESCRIPTION OF THE DRAWINGS

To more clearly illustrate the technical solutions in the embodiments of the present application or in the traditional art, the accompanying drawings required for describing the embodiments or the traditional art will be briefly introduced below. It is obvious that the drawings in the following description are only some embodiments recorded in the present application, and for those of ordinary skill in the art, other drawings can be obtained based on these drawings without creative effort.

FIG. 1 is a schematic diagram of the data transmission principle of a switch in traditional art;

FIG. 2 is a schematic flowchart of the operation of a switch provided by an exemplary embodiment of the present disclosure;

FIG. 3 is a schematic diagram of the data transmission principle of a switch provided by an exemplary embodiment of the present disclosure;

FIG. 4 is a schematic diagram of the circuit architecture in a four-port switch provided by an exemplary embodiment of the present disclosure.

### DETAILED DESCRIPTION

To enable those skilled in the art to better understand the solutions of the present disclosure, the technical solutions in the embodiments of the present disclosure will be clearly and completely described below in conjunction with the accompanying drawings in the embodiments of the present disclosure. Obviously, the described embodiments are only a part of the embodiments of the present disclosure, not all of them. Based on the embodiments in the present disclosure, all other embodiments obtained by a person of ordinary skill in the art without making creative efforts shall fall within the protection scope of the present disclosure.

It should be noted that terms such as “first” and “second” in the description and claims of the present disclosure and the above drawings are used to distinguish similar objects, and not necessarily to describe a specific order or sequence. It should be understood that the data so used may be interchanged under appropriate circumstances, so that the embodiments of the present disclosure described herein can be implemented in an order other than that illustrated or described herein. In addition, the terms “comprises” and “has” and any variations thereof are intended to cover a non-exclusive inclusion. For example, a process, method, apparatus, product, or device that comprises a series of steps or units is not necessarily limited to those clearly listed steps or units, but may include other steps or units not clearly listed or inherent to such processes, methods, products, or devices.

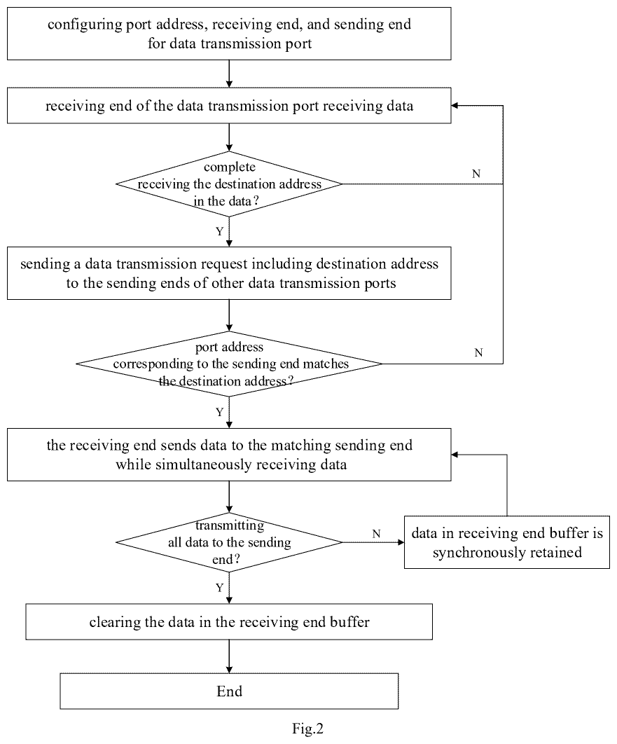

In one embodiment of the present disclosure, a switch for reducing data exchange latency is provided. Referring to FIG. 2 to FIG. 4, the switch comprises a plurality of data transmission ports electrically interconnected. Each of the data transmission ports is configured with a port address, port addresses corresponding to different data transmission ports are different, and each of the data transmission ports comprises a receiving end and a sending end. The receiving end is configured with a corresponding receiving end buffer, and the receiving end buffer is configured to store data received by the receiving end. The sending end is configured with a sending end buffer, and the sending end buffer is configured to store data received by the sending end.

The receiving end of the data transmission port is configured to receive data transmitted from an external source to the switch and to forward the data to the sending ends of other data transmission ports; the sending end of the data transmission port is configured to receive the data sent from the receiving ends of the other data transmission ports;
the receiving end of the data transmission port receives data and stores the data into its corresponding receiving end buffer, the data comprising a destination address, the destination address being one of the plurality of port addresses;
when completing the reception of the destination address of the data, the receiving end sends a data transmission request to the sending ends of the other data transmission ports, the data transmission request comprising the destination address;
the sending ends of the other data transmission ports receive the data transmission request and match the destination address with their corresponding port addresses, and the sending end with a matching address returns an acknowledgement signal to the receiving end;
the receiving end, in response to receiving the acknowledgement signal, sends data to the corresponding sending end, and the sending end receives the data and stores the data into its corresponding sending end buffer.

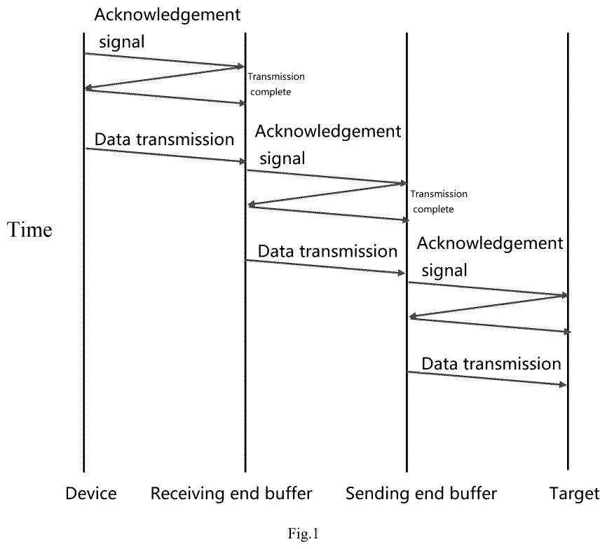

Existing switch technologies have significant problems in terms of data transmission latency. Because data must be completely received before the next step of sending can proceed, as shown in FIG. 1, after an external device completely transmits data to the receiving end buffer, the receiving end will send the data stored in the receiving end buffer to the target sending end only after obtaining an acknowledgement signal from the target sending end. Similarly, the sending end will send the data from its sending end buffer to the target only after completely receiving the data and confirming the acknowledgement signal returned by the target, which leads to high latency.

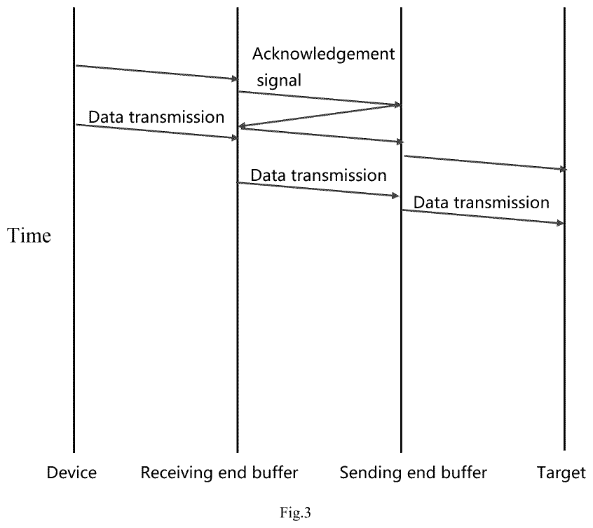

The switch provided by the present disclosure greatly reduces latency by changing the way data is received and sent, and by changing the path between buffers within the switch. As shown in FIG. 3, the receiving end in this switch does not need to completely receive the data before proceeding to the next step of transmission. It only needs to finish receiving the destination address in the data to generate a data transmission request and send it to the sending ends of all other data transmission ports. The data transmission request includes the destination address. The port address that matches the destination address is identified, and that port address is determined to be the target sending end. The target sending end will return an acknowledgement signal to the receiving end. After receiving the acknowledgement signal, the receiving end sends data to the target sending end while simultaneously receiving data itself. As shown in FIG. 3, the sending end receives data and synchronously sends the received data to the exterior of the switch. This saves a significant amount of time for storing data in the receiving end buffer and sending end buffer, as well as the time waiting to send the data transmission request signal and waiting for the acknowledgement signal to return, effectively reducing the latency of the data exchange process.

The switch for reducing data exchange latency provided by the present disclosure, based on a plurality of data transmission ports, allows a device to simultaneously receive data from other devices in the switch while sending data to the switch, and simultaneously send data to other devices, which can further reduce data transmission latency and improve data transmission efficiency. The above steps can be performed in a laboratory environment, and the required equipment includes a switch, a bus (such as PCIe), a computer, etc. The capacity of the receiving end buffer and the sending end buffer of the switch can be set according to actual needs to ensure the efficiency and accuracy of data transmission. The computer can be used to send and receive data, as well as to monitor the latency and accuracy of data transmission.

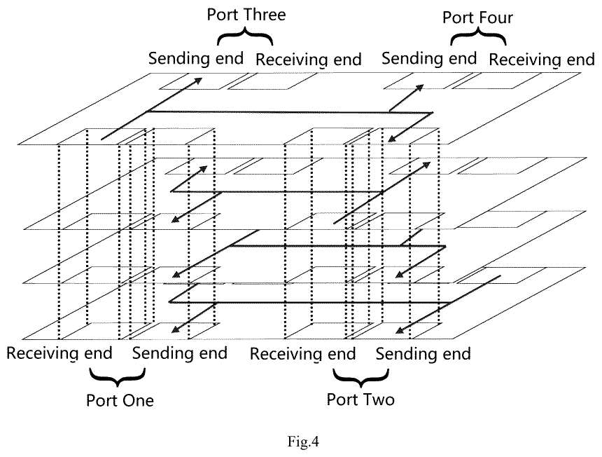

In one embodiment of the present disclosure, as shown in FIG. 4, the switch comprises N data transmission ports, and the N data transmission ports are arranged on N circuit layers. Each circuit layer comprises the receiving end of one of the data transmission ports and the sending ends of the other data transmission ports, and the receiving end of the one data transmission port is electrically connected to the sending ends of the other data transmission ports respectively. Specifically, configure N independent circuit layers. The first circuit layer is used to lay out the electrical connection lines between the receiving end of the first data transmission port and the sending ends of the other N-1 data transmission ports. The second circuit layer is used to lay out the electrical connection lines between the receiving end of the second data transmission port and the sending ends of the other N-1 data transmission ports, and so on.

In this embodiment, data transmission is performed between the receiving end and the sending ends on the same circuit layer, and no data transmission is performed between receiving ends and sending ends on different circuit layers, which means the electrical connection lines between the receiving end and sending ends on a certain circuit layer are not electrically connected to other circuit layers. The receiving ends and the sending ends on each circuit layer perform data transmission mutually independently. The receiving ends and the sending ends on each circuit layer are capable of performing data transmission simultaneously.

Specifically, as shown in the 4-layer circuit architecture suitable for 4 data transmission ports provided in FIG. 4, the two data transmission ports on the front side of each layer are port one and port two from left to right, and the two data transmission ports on the rear side of each layer are port three and port four from left to right. Port one to port four are all configured with a receiving end and a sending end, as well as corresponding buffers.

Wherein, on the first layer, the receiving end of port one is electrically connected to the sending ends of port two to port four respectively; on the second layer, the receiving end of port two is electrically connected to the sending ends of port one, port three, and port four respectively; on the third layer, the receiving end of port three is electrically connected to the sending ends of port one, port two, and port four respectively; on the fourth layer, the receiving end of port four is electrically connected to the sending ends of port one, port two, and port three respectively. The four data transmission ports are arranged on four circuit layers, which means that the first circuit layer is used for the receiving end of port one to receive data containing a destination address, and then to send requests containing the destination address to the sending ends of port two, port three, and port four, respectively; while the second circuit layer is used for the receiving end of port two to receive data containing a destination address, and then to send requests containing the destination address to the sending ends of port one, port three, and port four, respectively; while the third circuit layer is used for the receiving end of port three to receive data containing a destination address, and then to send requests containing the destination address to the sending ends of port one, port two, and port four, respectively; while the fourth circuit layer is used for the receiving end of port four to receive data containing the destination address, and then to send requests containing the destination address to the sending ends of port one, port two, and port three, respectively. Therefore, when data is currently sent from an external source to port three of the switch, the data is transmitted via the third circuit layer. This achieves mutually independent and simultaneous data transmission between the receiving ends and sending ends of different data transmission ports, which not only improves the efficiency of data transmission and reduces data transmission latency, but also ensures that the data transmission channels do not interfere with each other, guaranteeing the reliability of data transmission.

Unlike the traditional art where the receiving end and sending end of the same data transmission port share the same buffer, in the present application, a buffer is configured for the receiving end and the sending end of each data transmission port respectively. This allows for full utilization of the bidirectional transmission provided by the bus. The receiving end buffer is electrically connected to each sending end buffer, and by adding a buffer, the received data and sent data are separated into different buffers, reducing the waiting latency caused by a port's buffer being unable to receive data because it is currently sending data during transmission within the switch.

To further improve the reliability of data transmission, in one embodiment of the present disclosure, during the receiving end is sending data to the sending end, the data in the receiving end buffer corresponding to the receiving end is synchronously retained. Specifically, both the sent and unsent data in the receiving end buffer are synchronously retained and will not be cleared. The data stored in the receiving end buffer is cleared only after the receiving end has completed sending a set of data to the sending end. At the same moment, one receiving end buffer retains only one set of data.

Similarly, during the sending end is sending data to the exterior of the switch, the data in the sending end buffer corresponding to the sending end is synchronously retained. Specifically, both the sent and unsent data in the sending end buffer continue to be retained in the sending end buffer and will not be cleared. The data stored in the sending end buffer is cleared only after the sending end has completed sending a set of data to the exterior of the switch. At the same moment, one sending end buffer retains only one set of data.

When the sending process is interrupted or aborted while the receiving end is sending data to the sending end, then when the receiving end sends data to the sending end again, it sends all the data from its corresponding receiving end buffer to the sending end, and the sending end receives the data and stores and/or replaces the data in its corresponding sending end buffer.

When the sending process is interrupted or aborted while the sending end is sending data to the exterior of the switch, then when the sending end sends data to the exterior of the switch again, it sends all the data from its corresponding sending end buffer to the exterior of the switch.

Based on the above optimized data re-transmission mechanism, the data transmission mode for data within the switch can be changed. Only one set of data is retained in the sending and receiving buffers. When the destination end (external device) fails a data check, the destination end will discard/abort the data transmission. During re-transmission, the destination end only needs to re-receive all the data in the sending end buffer, without needing to find the storage address in the sending end buffer, thereby improving the efficiency of data re-transmission.

In present switch technology, when the receiving end buffer is processing other data and cannot respond in a timely manner during data transmission, the sending end buffer will temporarily store this set of transmission data while continuing to receive data until the buffer is full. When transmission begins, it is necessary to find the data location in the buffer, which also increases latency. This technical solution, through the above optimized data re-transmission mechanism, improves the efficiency of data re-transmission and solves the problem of data re-transmission efficiency.

The technical solution of the present disclosure simplifies the data transmission process, reduces the storage and transmission time of data within the switch, and improves the efficiency of data transmission, thereby improving the performance of the entire computer system. In summary, compared to the traditional art, the present disclosure has significant advantages in terms of data transmission latency, utilization of the bidirectional transmission capability of the bus, efficiency of data retransmission, and simplification of the data transmission process.

In one embodiment of the present disclosure, a data transmission method for reducing latency is provided for transmitting data among a plurality of electrically connected data transmission ports, comprising the following steps:
configuring a port address for each of the data transmission ports, and configuring a receiving end and a sending end for each data transmission port, the receiving end being configured with a corresponding receiving end buffer, the receiving end buffer being configured to store data received by the receiving end, and the sending end being configured with a sending end buffer, the sending end buffer being configured to store data received by the sending end;
the receiving end of the data transmission port is configured to receive data and send the data to the sending ends of other data transmission ports; the sending end of the data transmission port is configured to receive the data sent from the receiving ends of the other data transmission ports;
the receiving end of the data transmission port receives data and stores it into its corresponding receiving end buffer, the data comprising a destination address, the destination address being one of the plurality of port addresses;
when the receiving end completes the reception of the destination address of the data, it sends a data transmission request to the sending ends of the other data transmission ports, the data transmission request comprising the destination address;
the sending ends of the other data transmission ports respectively receive the data transmission request and match the destination address with their corresponding port addresses, and the sending end with a matching address returns an acknowledgement signal to the receiving end;
the receiving end, in response to receiving the acknowledgement signal, sends data to the sending end that returned the acknowledgement signal, and the sending end receives the data and stores it into its corresponding sending end buffer. The sending end receives data and synchronously sends the received data to an external destination.

In this embodiment, the receiving end of each of the data transmission ports is configured to be electrically connected with the sending ends of the other data transmission ports; the receiving ends of different data transmission ports and the sending ends of the other data transmission ports perform data transmission mutually independently. During the receiving end is sending data to the sending end, the data in the receiving end buffer corresponding to the receiving end is synchronously retained; the data stored in the receiving end buffer is cleared only after the receiving end has completed sending a set of data to the sending end.

In one embodiment of the present disclosure, a data transmission system is provided, which performs data transmission using the data transmission method for reducing latency as described above.

The data transmission method and data transmission system for reducing latency provided by the present disclosure can have wide applications in fields such as computer systems, high-speed data transmission equipment, and bus equipment. First, in computer systems, a switch is a crucial device used to connect multiple computers or other network devices for high-speed data transmission. This technical solution reduces latency and achieves simultaneous sending and receiving of data at a port by changing the way data is received and sent and changing the path between buffers within the switch. This will greatly improve the performance of computer systems, especially the efficiency and speed of data transmission. Second, in high-speed data transmission equipment, this technical solution can fully utilize the bidirectional transmission capability provided by the bus. During a device sends data to the switch, it can simultaneously receive data from other devices, which will greatly improve the efficiency and speed of data transmission and reduce data transmission latency. Finally, in bus equipment, this technical solution reduces latency and achieves simultaneous sending and receiving of data at a port by changing the way and path data is transmitted within the switch, which will greatly improve the performance of bus equipment, especially the efficiency and speed of data transmission. In summary, this technical solution has broad application prospects in fields such as computer systems, high-speed data transmission equipment, and bus equipment, with huge market demand and great commercial value.

It should be noted that the embodiments of the data transmission method and data transmission system for reducing latency provided by the present disclosure have the same inventive concept as the above embodiments of the switch for reducing data exchange latency, and the entire content of the embodiments of the switch for reducing data exchange latency is incorporated into the embodiments of the data transmission method and data transmission system for reducing latency by reference.

It should be noted that in this text, relational terms such as first and second are only used to distinguish one entity or operation from another, and do not necessarily require or imply any such actual relationship or order between these entities or operations. Moreover, the terms “comprises”, “comprising”, or any other variation thereof are intended to cover a non-exclusive inclusion, such that a process, method, article, or apparatus that comprises a list of elements does not include only those elements but may include other elements not expressly listed or inherent to such process, method, article, or apparatus. Without more constraints, an element preceded by “comprises a . . . ” does not preclude the existence of additional identical elements in the process, method, article, or apparatus that comprises the element.

The above are only specific embodiments of the present application. It should be pointed out that for a person of ordinary skill in the art, several improvements and modifications can be made without departing from the principles of the present application, and these improvements and modifications should also be regarded as falling within the protection scope of the present application.

1. A switch for reducing data exchange latency, comprising a plurality of data transmission ports electrically interconnected, wherein each data transmission port is configured with a port address, and each data transmission port comprises a receiving end and a sending end; the receiving end is configured with a corresponding receiving end buffer, which is configured to store data received by the receiving end; and the sending end is configured with a sending end buffer, which is configured to store data received by the sending end;
the receiving end of the data transmission port is configured to receive data transmitted from an external source to the switch and to forward the data to sending ends of other data transmission ports; the sending end of the data transmission port is configured to receive the data sent from receiving ends of the other data transmission ports;
the receiving end of the data transmission port receives data and stores the data into corresponding receiving end buffer thereof, the data comprising a destination address, which is one of the plurality of port addresses;
when completing reception of the destination address of the data, the receiving end sends a data transmission request to the sending ends of the other data transmission ports, the data transmission request comprising the destination address;
the sending ends of the other data transmission ports receive the data transmission request and match the destination address with corresponding port addresses thereof, and the sending end whose port address is matched returns an acknowledgement signal to the receiving end;
the receiving end, in response to receiving the acknowledgement signal, sends data to the sending end that returned the acknowledgement signal, and the sending end receives the data and stores the data into corresponding sending end buffer thereof;
the switch comprises N data transmission ports, and the N data transmission ports are arranged on N circuit layers;
each circuit layer comprises the receiving end of one of the data transmission ports and the sending ends of the other data transmission ports, and the receiving end of one data transmission port is electrically connected to the sending ends of the other data transmission ports respectively;
data transmission is performed between the receiving end and the sending ends on the same circuit layer, and no data transmission is performed between receiving end and sending ends on different circuit layers;
at the same moment, one receiving end buffer retains only one set of data; and/or, at the same moment, one sending end buffer retains only one set of data.

2. The switch for reducing data exchange latency according to claim 1, wherein data transmission between the receiving end and the sending ends on each circuit layer is performed independently; and/or,
data transmission between the receiving end and the sending ends on each circuit layer can be performed simultaneously.

3. The switch for reducing data exchange latency according to claim 1, during the receiving end is sending data to the sending end; the data in the receiving end buffer corresponding to the receiving end is synchronously retained;
the data stored in the receiving end buffer is cleared only after the receiving end has completed sending one set of data to the sending end.

4. The switch for reducing data exchange latency according to claim 3, when the data transmission from the receiving end to the sending end is interrupted or aborted, then all the data from corresponding receiving end buffer thereof would be sent to the sending end when the receiving end sends data again, and the sending end receives the data and stores and/or replaces the data in corresponding sending end buffer thereof.

5. The switch for reducing data exchange latency according to claim 1, wherein the sending end receives data and synchronously forwards the received data to exterior of the switch.

6. The switch for reducing data exchange latency according to claim 5, wherein, during the sending end is sending data to the exterior of the switch, the data in the sending end buffer corresponding to the sending end is synchronously retained;
the data stored in the sending end buffer is cleared only after the sending end has completed sending one set of data to the exterior of the switch.

7. The switch for reducing data exchange latency according to claim 6, when the data transmission from the sending end to the exterior of the switch is interrupted or aborted, then all the data from corresponding sending end buffer thereof would be sent to the exterior of the switch when the sending end sends data again.

8. A data transmission method for reducing latency, applied to the switch for reducing data exchange latency according to claim 1, for transmitting data among a plurality of data transmission ports electrically interconnected, comprising the following steps:
configuring a port address for each data transmission port, and configuring a receiving end and a sending end for each data transmission port, the receiving end being configured with a corresponding receiving end buffer to store data received by the receiving end, and the sending end being configured with a sending end buffer to store data received by the sending end;
the receiving end of the data transmission port is configured to receive data and forward the data to sending ends of other data transmission ports; the sending end of the data transmission port is configured to receive the data sent from receiving ends of the other data transmission ports;
the receiving end of the data transmission port receives data and stores the data into corresponding receiving end buffer thereof, the data comprising a destination address, which is one of the plurality of port addresses;
when completing reception of the destination address of the data, the receiving end sends a data transmission request to the sending ends of the other data transmission ports, the data transmission request comprising the destination address;
the sending ends of the other data transmission ports respectively receive the data transmission request and match the destination address with corresponding port addresses thereof, and the sending end whose port address is matched returns an acknowledgement signal to the receiving end;
the receiving end, in response to receiving the acknowledgement signal, sends data to the sending end that returned the acknowledgement signal, and the sending end receives the data and stores the data into corresponding sending end buffer thereof.

9. The data transmission method for reducing latency according to claim 8, further comprising configuring the receiving end of each of the data transmission ports to be electrically connected with the sending ends of the other data transmission ports;
the receiving ends of different data transmission ports and the sending ends of the other data transmission ports perform data transmission mutually independently.

10. The data transmission method for reducing latency according to claim 9, wherein the sending end receives data and synchronously sends the received data to an external destination; and/or,
during the receiving end is sending data to the sending end, the data in the receiving end buffer corresponding to the receiving end is synchronously retained; the data stored in the receiving end buffer is cleared only after the receiving end has completed sending one set of data to the sending end.

11. A data transmission system, which performs data transmission using the data transmission method for reducing latency according to claim 8.
